(19) United States
(12) Patent Application Publication
(10) Pub. No.: US 2025/0165599 A1
(43) Pub. Date: May 22, 2025

(54) AI-DRIVEN CONTEXTUAL FILTERING SYSTEM FOR A2P MESSAGING

(71) Applicant: DISH Wireless L.L.C., Littleton, CO (US)

(72) Inventors: Mihir Bhatt, Denver, CO (US); Jaynish Patel, Muskegon, MI (US)

(21) Appl. No.: 18/517,356

(22) Filed: Nov. 22, 2023

(51) Int. Cl. G06F 21/56; G06F 21/57; H04L 51/212

(52) U.S. Cl. CPC G06F 21/562; G06F 21/577; H04L 51/212

(57) ABSTRACT

A method may include receiving, by a computing system, a plurality of messages. The method may include determining, by the computing system and utilizing a machine learning model, a score for a respective message of the plurality of messages, the score representing a likelihood that the respective message is an illegitimate message. The method may include accessing, by the computing system, a database that includes a list including a respective sender associated with the respective message, the respective sender associated with the rating. The method may include updating, by the computing system, a rating of the respective sender associated with the respective message, based at least in part on the score of the respective message. The method may include filtering, by the computing system, at least a portion of the plurality of messages based at least in part on the rating of the respective sender.

### BACKGROUND

As organizations continue to utilize technology to reach individuals, bad actors continue to find new ways to abuse the same technologies. Application to person (A2P) messaging is one such technology. A bad actor may try to take advantage not only of the recipient of a message, but the network(s) involved in the messaging as well.

### BRIEF SUMMARY

A system may include one or more processors and a machine learning model configured to identify one or more attributes of a message and, based at least in part on the one or more attributes, determine if the message is an illegitimate message. The system may also include a rating module configured to assign a rating to a sender of the message, the rating associated with a trust level of sender. The system may include a filtering module configured to filter the message from the sender. The system may also include a non-transitory computer readable-medium containing instructions that, when executed by the one or more processors, cause the system to perform operations. According to the instructions, the system may receive, by the system, a plurality of messages. The system may determine, by the machine learning model, a score for a respective message of the plurality of messages, the score based on the one or more attributes of the respective message representing a likelihood that the respective message is an illegitimate message. The system may access, by the rating module, a database that includes a list including a respective sender associated with the respective message, the respective sender associated with the rating. The system may update, by the rating module, the rating of the respective sender associated with the respective message, based at least in part on the score of the respective message. The system may filter, by the filtering module, at least a portion of the plurality of messages based at least in part on the rating of the respective sender.

In some embodiments, the one or more attributes may include at least one of an internet protocol (IP) address, metadata, and a message content. The machine learning model may be configured to identify a route of the respective message and the score may be based at least in part on the route of the respective message. The machine learning model may be configured to identify an illegitimate message of the plurality of messages based at least in part on the content of the illegitimate message, and the score may be based at least in part on the content of the illegitimate message. The machine learning model may include a large language model. The machine learning model may be retrained using feedback provided by a plurality of users. The computing system may be associated with an enterprise-level system. The machine learning model may include natural language processing techniques.

A non-transitory computer-readable medium may include instructions that, when executed by one or more processors, cause the one or more processors to perform operations. The operations may include receiving, by a computing system, a plurality of messages. The operations may include determining, by the computing system and utilizing a machine learning model, a score for a respective message of the plurality of messages, the score representing a likelihood that the respective message is an illegitimate message. The operations may include accessing, by the computing system, a database that includes a list including a respective sender associated with the respective message, the respective sender associated with the rating. The operations may include updating, by the computing system, a rating of the respective sender associated with the respective message, based at least in part on the score of the respective message. The operations may include filtering, by the computing system, at least a portion of the plurality of messages based at least in part on the rating of the respective sender.

In some embodiments, determining, by the computing system utilizing a machine learning model, the score for the respective message of the plurality of messages may further include: determining, by the machine learning model, a context associated with the respective message of the plurality of messages, the context based on information associated with at least one of the respective message, the respective sender, and an intended recipient. The computing system may be associated with an enterprise-level system. The machine learning model may include natural language processing techniques. The method where the machine learning model may be configured to identify a route of each respective message and the score is based at least in part on the route of each respective message. The machine learning model may be configured to identify an illegitimate message of the plurality of messages based at least in part on the content of the illegitimate message, and the score may be based at least in part on the content of the illegitimate message.

A method may include receiving, by a computing system, a plurality of messages. The method may include determining, by the computing system and utilizing a machine learning model, a score for a respective message of the plurality of messages, the score representing a likelihood that the respective message is an illegitimate message. The method may include accessing, by the computing system, a database that includes a list including a respective sender associated with the respective message, the respective sender associated with the rating. The method may include updating, by the computing system, a rating of the respective sender associated with the respective message, based at least in part on the score of the respective message. The method may include filtering, by the computing system, at least a portion of the plurality of messages based at least in part on the rating of the respective sender.

In some embodiments, determining, by the computing system utilizing a machine learning model, the score for the respective message of the plurality of messages may further include determining, by the machine learning model, a context associated with the respective message of the plurality of messages, the context based on information associated with at least one of the respective message, the respective sender, and an intended recipient. The computing system may be associated with an enterprise-level system. The machine learning model may include natural language processing techniques. The method where the machine learning model may be configured to identify a route of each respective message and the score is based at least in part on the route of each respective message. The machine learning model may be configured to identify an illegitimate message of the plurality of messages based at least in part on the content of the illegitimate message, and the score may be based at least in part on the content of the illegitimate message.

### BRIEF DESCRIPTION OF THE DRAWINGS

FIG. 1 illustrates a system and a process for filtering application to person messages, according to certain embodiments.

FIG. 2 illustrates a system for training a machine learning model with various datasets, according to certain embodiments.

FIG. 3 illustrates a system for generating a message score to update a rating, according to certain embodiments.

FIG. 4 illustrates a system for filtering A2P messages identified as illegitimate, according to certain embodiments.

FIG. 5 illustrates a flowchart of a method for filtering A2P messages based on context, according to certain embodiments.

FIG. 6A illustrates an embodiment of a cellular network system, according to certain embodiments.

FIG. 6B illustrates an exemplary core, according to certain embodiments.

FIG. 7 illustrates an embodiment of a cellular network core network topology as implemented on a public cloud-computing platform, according to certain embodiments.

### DETAILED DESCRIPTION

Businesses and other entities are always looking for new ways to engage with their users (e.g., members, customers, etc.). Mailed advertisements have waned in favor of more targeted marketing via email, for example. Spam has since pervaded email generally, and many emails may be spoofed, or appear to be from someone other than the actual sender. The sender of these emails may be attempting to steal data or trick the recipient of the email or perform some other fraud. As technology has evolved again, however, bad actors have also evolved, attempting to leverage other systems with bad intentions.

One example of this is application to person (A2P) messaging. A2P messaging is prevalent already, and growing in use by many different entities. A small business, for example, may utilize a marketing service that sends short-messaging service (SMS) messages with coupons to one or more customers. An airline may send an SMS reminder about a flight status to a group of passengers or related individuals. A financial institution may send a one-time code via SMS to a user for dual authentication purposes. Other examples of A2P messaging are readily evident. A bad actor, however, may generate an SMS that appears to be from a legitimate application (as described above) with a link to enter some personal data (e.g., phishing). In other words, the bad actor may send an SMS to take advantage of an end user. In another example, the bad actor may alternately route an otherwise legitimate message from an application through improper channels, avoiding paying the proper amount per SMS to a wireless network provider (e.g., a mobile network operator (MNO) or a mobile virtual network operator (MVNO)). This fraudulent routing of A2P messages may be referred to as “gray routing.”

Whether targeting a message recipient or the network(s) used to transmit the SMS, it may be possible to identify and filter these messages on a user equipment (UE) level. The user associated with the UE may therefore be protected, either receiving a warning indicating that the SMS is likely to be illegitimate or not receiving the SMS at all. In order to reach the UE, however, the SMS still had to utilize the wireless network and resources thereof. In person to person messaging, this may be a practicable solution—an individual may only send so many SMS messages in a given time. With A2P messaging, an applicaiton may send thousands of messages at a time, utilizing significant resources of the wireless network provider. This not only costs the wireless network provider bandwidth on the wireless network, but also significant lost revenue (in the case of gray routing). Therefore, there is a need to identify and filter A2P messages on a wireless network provider (or enterprise) level.

One solution may be to monitor A2P messages as they are received from an application by a wireless network provider. The wireless network provider can evaluate some or all of the messages sent by the application to determine a score for a respective message using a machine learning module (MLM). For example, a particular application may historically transmit A2P messages to customers notifying the customers of a coupon. The wireless network provider may then receive a message from the particular application that contains a link and/or language asking for personal identifying information (PII). The MLM may then assign a score indicating that the message is likely an illegitimate message. In another example, the MLM may evaluate the behavior of a recipient (or group of recipients) and determine that a particular reaction is abnormal compared to a usual reaction to A2P messages sent by the particular application. The MLM may then assign a score indicating that the message may be illegitimate and/or flag the A2P message(s) for further analysis. In other words, the MLM may be used to build a context of the A2P message, where the message, historical messages, applicaiton behavior, user behavior, and other such information are considered.

Using the score of the A2P messages, the wireless network provider may update a rating associated with the application (or entity associated therewith). The rating may include a sender rating and be related to a number of A2P messages the entity is allowed to transmit within a given period. For example, if the score is too low, or there are frequent messages from the entity with low scores, the rating may be adjusted such that the entity is allowed fewer A2P messages, some or all of the A2P messages are filtered, a pay rate is increased, or other such examples. Thus, the wireless network provider may filter the A2P messages based on the output of the MLM.

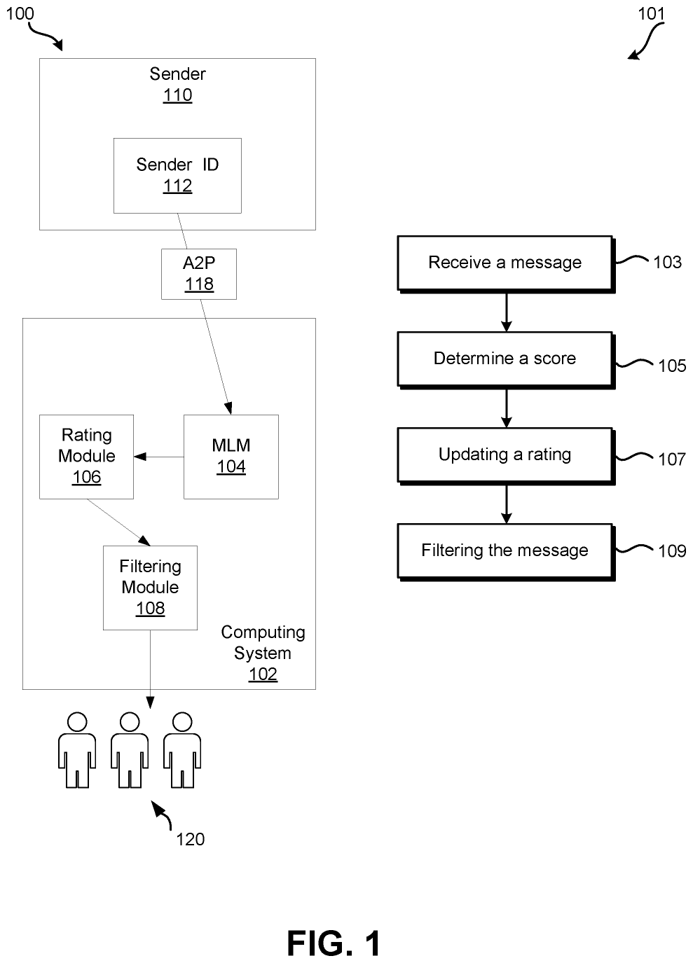

FIG. 1 illustrates a system 100 and a process 101 for filtering application to person (A2P) messages, according to certain embodiments. The system 100 may include a computing system 102, associated with a wireless network provider. The wireless network provider may be a standalone 5G network provider. Some or all of the components of the computing system 102 may be distributed across a cloud architecture, hosted on a publicly available cloud network. The components of the computing system may include a machine learning model (MLM) 104, a rating module 106, and a filter module 108. The computing system 102 may also communicate with one or more functions of a 5G core of the wireless network provider such as a short message service center (SMSC), an access management function (AMF), a charging function (CHF) or any other appropriate function.

The MLM 104 may include one or more machine learning modules, configured to determine contextual data about users, a receiving entity, a sending entity, an A2P message, etc. Thus, the MLM 104 may utilize natural language processing, a large language model, an artificial neural network, and other appropriate modules. The MLM 104 may be trained on historical behavioral data associated with users 120. The users 120 may be a group of individuals related in someway (e.g., subscribers to the wireless network provider, employees of an organization, etc.). The historical behavioral data may provide a baseline of normal activity of the users 120, individually and/or as a group.

The MLM 104 may also be trained on historical application data. The historical application data may include data related to a sender 110 and/or a sender IDsender ID 112. The sender ID 112 may include a short code, 10DLCC, or other such identifier used to communicate A2P messaging. The historical application data may provide a normal activity level of the sender 110 and/or an sender ID 112. The historical application data may also provide a normal content type of the sender 110 and/or the sender ID 112. One of ordinary skill in the art would recognize many different possibilities and data sets with which to train the MLM 104.

The computing system 102 may also include a rating module 106. The rating module 106 may include a list of senders and/or sender IDs (e.g., the sender 110 and/or the sender ID 112) with a rating indicating one or more attributes associated with the senders and/or the sender ID. The rating may be used by the wireless network provider to adjust the attributes (e.g., a permitted number of A2P messages, a cost structure, etc.) of the senders and/or the sender IDs. The computing system 102 may also include a filtering module 108. The filtering module 108 may block some or all A2P messages from a particular sender and/or sender ID. The filtering module 108 may filter the A2P messages based on the content of the A2P message, the rating (according to the rating module 106), or other appropriate factors.

At step 103 of the process 101, the computing system 102 may receive an A2P 118 from the sender ID 112. The A2P 118 may be an SMS, a multimedia messaging service (MMS) message, a voice communication, or any other such communication. The sender ID 112 may be related to and/or a component of the sender 110. For example, the sender 110 may be a bank, and the sender ID 112 may be a sender ID used for sending one time passcodes (OTPs) to users for dual authentication. In another example, the sender 110 may be a small business using a third-party marketing service to reach customers. The sender ID 112 may be part of a service offering of the third-party marketing service and the A2P 118 may indicate that the A2P 118 is from the small business. Other examples are readily apparent. Although only one A2P 118 is represented, it should be understood that the A2P 118 may represent a plurality of messages, sent to one or more users (e.g., the users 120). The each of the respective messages in the plurality of messages may be identical, or may be different from each other.

At step 105 of the process 101, the MLM 104 may determine a score associated with A2P 118. The score may represent a likelihood that the A2P 118 is an illegitimate message. For example, the MLM 104 may determine that the A2P 118 includes content differing from the type of content normally sent in messages from the sender ID 112 and/or the sender 110. The MLM 104 may utilize a large language model to analyze the content, comparing the content to historical messages from the sender 110 and/or to known illegitimate messages. The MLM 104 may additionally or alternatively analyze the content for misspellings, poor grammar, keywords, or other such markers that may indicate that the A2P 118 is an illegitimate message. Furthermore, the MLM 104 may analyze a route the A2P 118 took to be received by the users 120. The route may include IP addresses, various other wireless networks, foreign entities and other similar parties.

The MLM 104 may additionally or alternatively analyze metadata associated with the A2P 118. The metadata may include an internet protocol (IP) address, routing information (e.g., received from an AMF and/or SMSC), charging information (e.g., a CHF), destination information, and other such information. The MLM 104 may compare the metadata to historical metadata associated with other A2P messages sent by the sender 110 and/or the sender ID 112.

The MLM 104 may additionally or alternatively determine behavioral data associated with the users 120. For example, the A2P 118 may include a certain data type, such as a promotional message. Some or all of the users 120 may typically ignore A2P messages with the certain data type. However, the computing system 102 may detect that the users 120 are interacting with the certain data type. The MLM 104 may then compare the past behavior of the users 120 to the current interaction with the certain data type.

By analyzing and determining various datasets (e.g., behavioral data, metadata, message content, etc.), the MLM 104 may determine the score of the A2P 118 not only based on the A2P 118 itself, but on the context with which it is sent and received. Because the context of all parties involved in the transmission is considered, the score may represent a more accurate measure of the legitimacy of the A2P 118. Whereas other systems may block too many A2P messages or not enough A2P messages, the score provided by the MLM 104 may find illegitimate messages where other systems might now, and allow other messages that may be incorrectly labelled as illegitimate.

At step 107, the computing system 102 may provide the score associated with the A2P 118 to the rating module 106. The rating module 106 may utilize the score, at least in part, to update a rating associated with the sender 110. For example, the wireless network provider may maintain a list of various senders and sender IDs (e.g., the sender 110 and the sender ID 112). The list may include attributes such as a cost structure, a volume of allowed A2P messages (e.g., the A2P 118), a sender rating, and other attributes. If the computing system 102 detects a certain amount of illegitimate A2P messages from the sender 110, the rating module 106 may lower the sender rating associated with the sender 110. Furthermore, the rating module 106 may adjust the one or more attributes associated with the sender 110 (e.g., lowering the volume of allowed A2P messages). For example, the computing system 102, using the MLM 104, may detect a sudden increase in a number of spam messages (e.g., the A2P 118). The rating module 106 may then lower the volume of allowed A2P messages for a certain time, saving bandwidth of the wireless network from being used by a flood of spam messages.

Then, at step 109, the filtering module 108 may prevent the A2P 118 from being delivered to the users 120. The filtering module 108 may prevent the A2P from being delivered to the users 120 based at least in part on the rating provided by the rating module 106. Additionally or alternatively, the filtering module 108 may prevent the A2P 118 from being delivered based on an output from the MLM 104. Thus, because the MLM 104 identifies the A2P 118 as illegitimate based on the context of the A2P 118, the system 100 and process 101 may filter A2P messages in a targeted manner at an enterprise level. Furthermore, the training sets used to train the MLM 104 may be updated, either in real time or periodically. Thus, the system 100 may “learn” from various messages and become more effective. In other words, as the factors determining the context of A2P messages received by various users changes, the system 100 may adapt to the changing context.

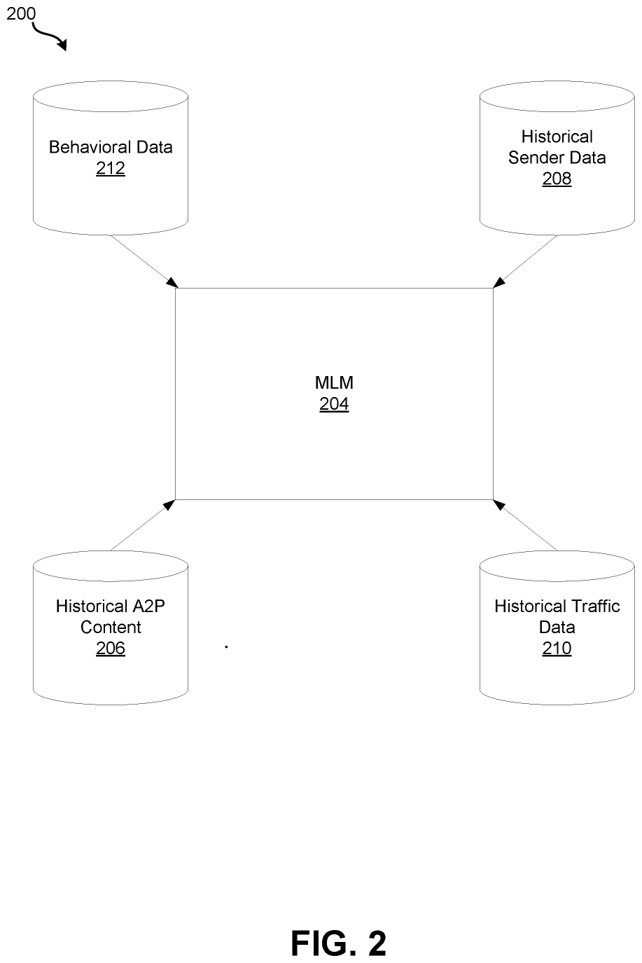

FIG. 2 illustrates a system 200 for training a machine learning model 204 with various datasets, according to certain embodiments. The MLM 204 may be similar to the MLM 104 in FIG. 1. As such the MLM 204 may include similar components and functionalities. For example, the MLM 204 may be a single MLM, or may include multiple MLMs performing similar or different functions and analyses. The MLM 204 may include one or more types of MLM, working independently and/or in collaboration with other types of MLM included in the MLM 204. For example, the MLM 204 may include natural language processing, a large language model, an artificial neural network, and other appropriate modules.

The MLM 204 may be trained on various datasets. The datasets may include historical A2P content 206, historical sender data 208, historical traffic data 210, and behavioral data 212. For example, the MLM 204 may be trained using the historical A2P content 206. The historical A2P content 206 may include information associated with the content of illegitimate A2P messages. The content of illegitimate messages may contain certain misspellings, grammatical patterns, language, and/or other aspects that may be common to illegitimate messages. For example, a phishing message may contain “URGENT” at the beginning of the message. Additionally or alternatively, the message may include misspellings and/or typos of particular words. The MLM 204 may thus be trained to recognize aspects of an A2P message's content that may be illegitimate. As illegitimate messages evolve and are identified (either by a system such as the system 100 and/or user inputs), the historical A2P content 206 may be updated accordingly.

The MLM 204 may also be trained on the historical sender data 208. The historical sender data 208 may include data associated with a particular sender of A2P messages (e.g., the sender 110 in FIG. 1) and/or and sender ID (e.g., the sender ID 112 in FIG. 1). The historical sender data 208 may therefore include information such as a normal A2P message type (e.g., SMS, MMS, etc.) and other data associated with the particular sender. For example, the particular sender may typically send SMS messages. In another example, the historical sender data 208 may be associated with the historical A2P content 206. Thus, the historical sender data 208 may be associated with certain content features, such as promotional language, OTP messages, a link to a webpage and/or other such features. The historical sender data 208 may also include typical metadata associated with the particular sender, such as IP addresses, routing information, wireless network information including network function information (e.g., CHF information), and other such information. The historical sender data 208 may also include a third party trust score, maintained by a third party (e.g., The Campaign Registry). The third party trust score may be associated with the sender and/or the sender ID. The MLM 204 may utilize the historical sender data 208 to further develop context for analyzing A2P messages such as the A2P 118.

The MLM 204 may also be trained on historical traffic data 210. The historical traffic data 210 may include information associated with the A2P messaging traffic of the particular sender. The information associated with the A2P messaging traffic of the particular sender may include a time window (e.g., a normal time the sender transmits A2P messages), a message volume, and other data related to the transmissions of A2P messages. The MLM 204 may therefore take into account the usual traffic of the particular sender, further developing context for analyzing A2P messages.

The MLM 204 may also be trained using behavioral data 212. The behavioral data 212 may include information about one or more users, either individually or as a cohort. The information may include a normal interaction rate associated with a certain type of A2P message (e.g., a promotional message), a reporting rate (e.g., how often a user reports a message as spam etc.), location information, and other such information. A cohort (or group of users) may include multiple users with a common trait such as an account type, an organizational association (e.g., employees of a company), a location, a subscription status (e.g., subscribed to an MVO or MVNO), and other such traits. In other words, the cohort may be clustered by their behaviors and/or associations. The MLM 204 may perform the clustering and analysis thereof (e.g., via k-means clustering and/or a similar technique or method), or the clustering may be performed by some other system. The MLM 204 may also be trained on other datasets not shown, but providing more context to the filtering of A2P messages.

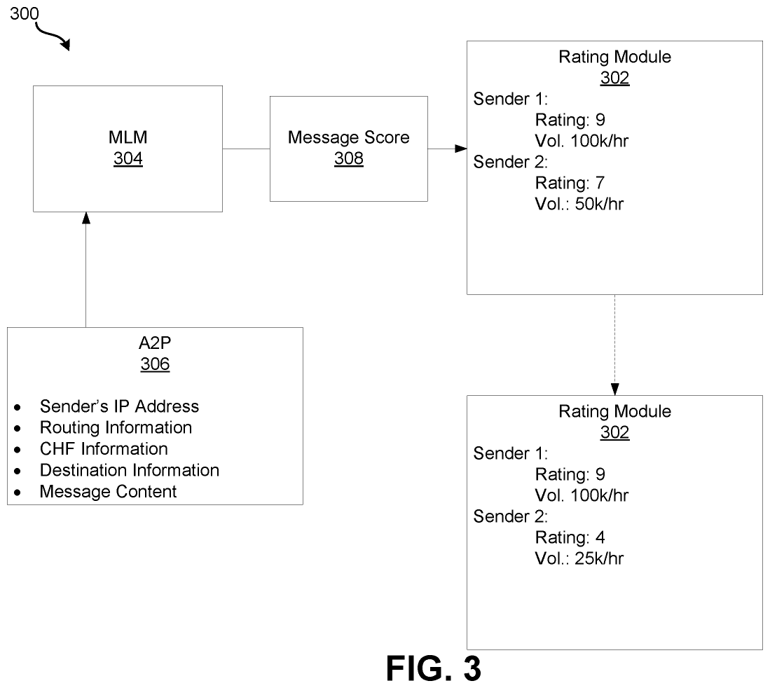

FIG. 3 illustrates a system 300 for generating a message score 306 to update a rating, according to certain embodiments. The system 300 may include an MLM 304 and a rating module 302. The MLM 304 may be similar to the MLM 104 in FIG. 1 and/or the MLM 204 in FIG. 2. The MLM 304 may therefore be trained on various datasets and configured to provide a score to any A2P messages received (e.g., by a wireless network provider or other enterprise). The MLM 304 may include one or more machine learning models, working individually or in conjunction with each other. The MLM 304 may include models such as natural language processing, a large language model, an artificial neural network, k-nearest neighbor models and other appropriate models. The various datasets used to train the MLM 304 may provide context with which the MLM 304 may consider before assigning the score to a particular A2P model.

As shown in FIG. 3, the MLM 304 may receive an A2P 306. Although only one A2P is shown in FIG. 3, it should be understood that the A2P 306 may represent any number of A2P messages. The A2P 306 may be received by a computing system such as the computing system 102 and from an application using a sender ID such as the sender ID 112 in FIG. 1. An intended recipient of the A2P 306 may be a user(s) of a wireless network provider such as the users 120. The A2P 306 may include metadata, such as a sender's IP address, routing information (e.g., which MVO/MVNO's were used in the transmission of the A2P, wireless network information, etc.), 5G (or other protocol) network function information such as CHF information, information indicating the intended recipient, message content, and other such information. The MLM 304 may then analyze some or all of information included in the A2P 306. In analyzing the A2P 306, the MLM 304 may consider the context of the sender, the recipient, the wireless network provider, and the A2P 306 itself.

Based on the analysis and the context, the MLM 304 may then generate a message score 308. The message score 308 may represent a likelihood that the A2P 306 is an illegitimate message, such as a spam message, a phishing message, or other messages. The message score 308 may also represent a likelihood that the A2P 306 was gray routed and should be charged differently than indicated by the CHF included in the A2P 306. The message score may be represented as a numerical value (e.g., 1-10), a percentage, a confidence interval, or any other suitable measure.

The message score 308 may then be provided to the rating module 302. The rating module 302 may include parameters associated with one or more senders. The parameters may include a sender rating, representing how trustworthy the sender is. In other words, the sender rating may indicate how likely a particular sender is to transmit legitimate messages vs. illegitimate messages. The parameters may also include a message volume indicating a number of A2P messages a sender is permitted to transmit in a given time frame. As seen in FIG. 3, at a first time (prior to the reception of the message score 308), sender 1 may have a sender rating of 9 and message volume of 100,000 message per hour. Sender 2 may have a sender rating of 4 and a message volume of 50,000 per hour.

In the example shown in FIG. 3, the A2P 306 may be an illegitimate message sent by (allegedly) sender 2. Given the context associated with the sender, the intended recipient(s), the A2P 306, and other contexts, the MLM 304 may assign the message score 308 indicating that the A2P is likely an illegitimate message. Based on the message score 308, the rating module 302 may adjust one or more of the parameters associated with sender 2. Thus, after receiving the message score 308, the rating module 302 may include parameters indicating that sender 2's sender rating has been lowered from 9 to 4, and that the message volume has been lowered from 50,000 per hour to 25,000 per hour. In other examples, sender 2's message volume may be lowered to zero (e.g., in response to a sudden flood of A2P messages that are likely to be illegitimate considering the context). Other example would be readily apparent to one of ordinary skill in the art.

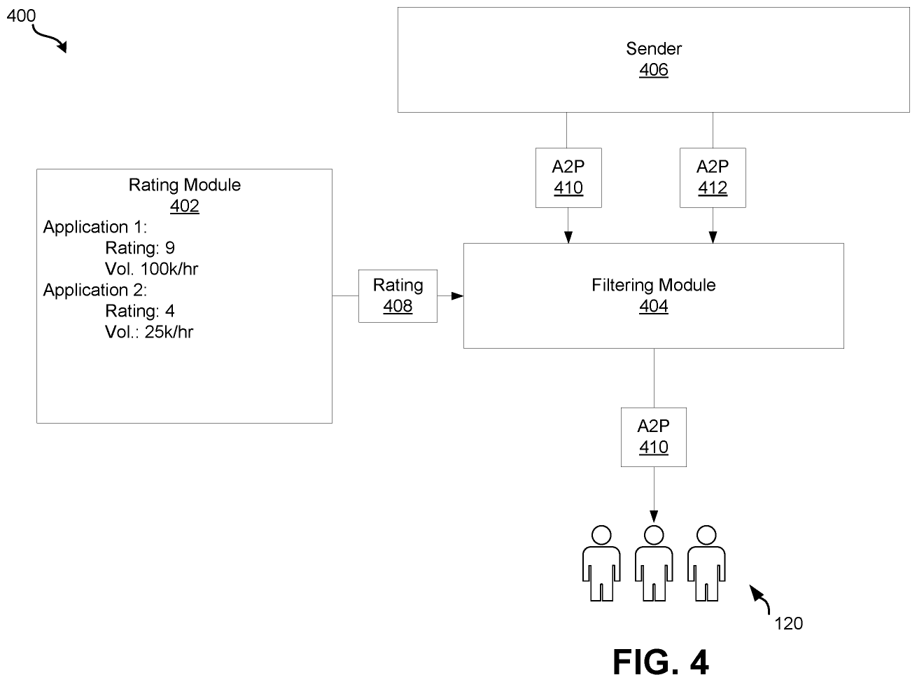

FIG. 4 illustrates a system 400 for filtering A2P messages identified as illegitimate, according to certain embodiments. The system 400 may be similar to some or all of the system 100 in FIG. 1. The system 400 may also be used in conjunction with the systems 200 and 300 in FIGS. 3 and 4, respectively. Thus, components of the system 400 may include similar components and functionalities as corresponding components of the systems 100, 200, and/or 300. The system 400 may include a rating module 402 and a filtering module. A sender 402 may be an entity that sends A2P messages (e.g., the A2P 306 from FIG. 3) to some or all of users 120.

The filtering module 404 may be a hardware and/or software component of a computing system (e.g., the computing system 102 in FIG. 1) that filters A2P messages according to the ratings in the rating module 402 or other such metrics included in the same or different systems. According to the ratings, the filtering module 404 may delete some or all A2P messages from a particular sender, store some or all A2P messages for further analysis and/or later delivery, and/or permit some or all of the A2P messages to be delivered to the users 120.

As seen in FIG. 4, the rating module 402 may provide a rating 408 to the filtering module 404. The rating 408 may indicate one or more parameters associated with one or more senders. Continuing the example from FIG. 3, the sender 406 may be “sender 2.” In relation to the sender 406, the rating module 402 may have lowered the sender rating from 9 to 4 and the message volume from 50,000 per hour to 25,000 per hour. The rating 408 may indicate the lowered sender rating and/or lowered message volume. The rating 408 may also indicate the context of the parameters, such that messages from the sender 406 may be selectively filtered. The filtering module 404 may therefore utilize the rating 408 to filter some or all of the A2P messages sent by the sender 406.

For example, the sender may transmit an A2P 410 and an A2P 412. The A2P 410 may be a message that is typical of the sender 406. If the sender 406 is a bank, the A2P 410 may be a OTP message used for dual authentication. The A2P 412 may appear to be a security alert, with metadata that is different than is usual for A2P messages sent from the sender 406. Thus, an MLM (e.g., the MLM 304) may have determined that the A2P 412 is likely an illegitimate message (based on language used, varying metadata, etc.). Thus, using information associated with the sender 406, the A2P 410, the A2P 412, the users 120, context considered by the MLM, etc., the filtering module 404 may cause the A2P 410 to be delivered to the user(s) 120, while not permitting the A2P 412 to be delivered.

Because the systems 100-400 described herein may be disposed at the wireless network provider level, the A2P 412 may be intercepted at or near the first point the A2P 412 enters the wireless network provider's systems (e.g., the computing device 102). Intercepting the A2P 412 at or near the entry point of the wireless network provider's systems allows illegitimate messages (e.g., the A2P 412) to be stopped before more resources are used to transmit the illegitimate messages through the wireless network.

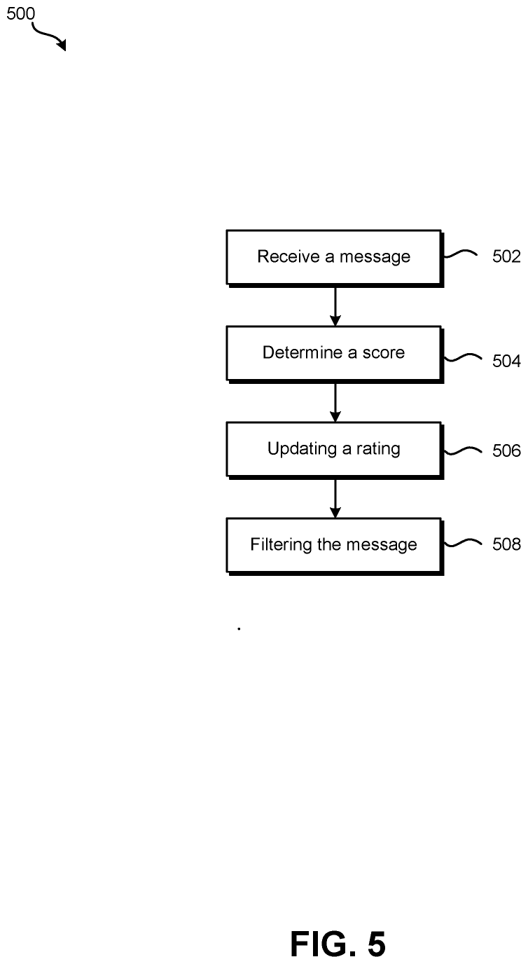

FIG. 5 illustrates a flowchart of a method 500 for filtering A2P messages based on context, according to certain embodiments. The method 500 may be performed by any or all of the systems described herein, such as the systems 100-400 in FIGS. 1-4, respectively. To perform the method 500, the systems 100-400 may work individually or in conjunction with one another. The steps of the method 500 may be performed in a different order than is shown or described herein, and/or combined with other steps. In some embodiments, some steps may be skipped altogether.

At step 502, the method 500 may include receiving, by a computing system, a plurality of messages. The plurality of messages may be an A2P message, sent from a sender by an application to one or more users. The computing system may be similar to the computing system 102 in FIG. 1. The computing system may be an enterprise-level system. For example, the computing system may be part of a wireless network and be configured to receive the plurality of messages at or near an entry point of the wireless network. The plurality of messages may include SMS messages, MMS messages, or any other type of message.

At step 504, the method 500 may include determining, by the computing system and using an MLM, a score for each respective message of the plurality of messages. The score may represent a likelihood that the respective message is an illegitimate message. In determining the score, the MLM may also determine a context associated with each respective message of the plurality of messages. The context based on information associated with at least one of the respective message, the respective sender, and an intended recipient. For example, the MLM may “learn” the context based on various datasets, such as those described in FIG. 2.

The MLM may include one or more modules or individual machine learning models. The one or more modules may work independently and/or in collaboration with other modules included in the MLM to determine the score and/or the context associated with the respective message. For example, the MLM may include natural language processing, a large language model, an artificial neural network, a k-nearest neighbor models, and other appropriate modules.

At step 506, the method 500 may include updating, by the computing system, a rating of each respective sender associated with each respective message. The rating may be based at least in part on the score of each respective message. The rating may include information associated with each respective sender such as a trust level and/or a permitted message volume (e.g., as described in FIG. 3). Updating the rating may include raising or lowering one or more parameters of the rating according to the score (e.g., lowering the trust level from 9 to 4).

At step 508, the method 500 may include filtering, by the computing system, at least a portion of the plurality of messages based at least in part on the rating of each respective sender. The filtering may be further based on the context identified by the MLM. For example, as shown in FIG. 4, a filtering module may filter one A2P message because, given the context, the A2P message is not likely to be illegitimate. The filtering module may filter another A2P message (again based on the context) because the other A2P message is likely to be illegitimate.

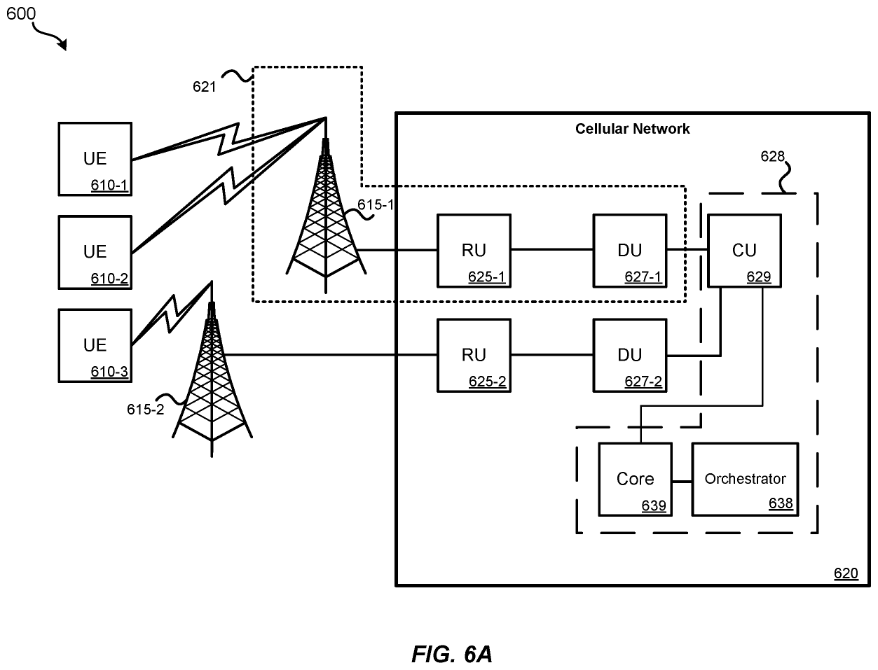

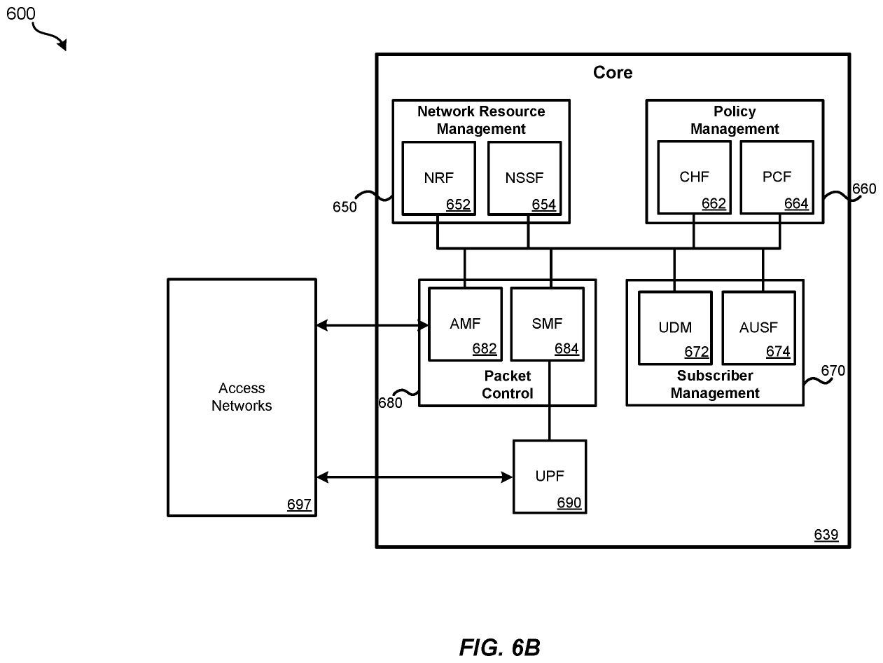

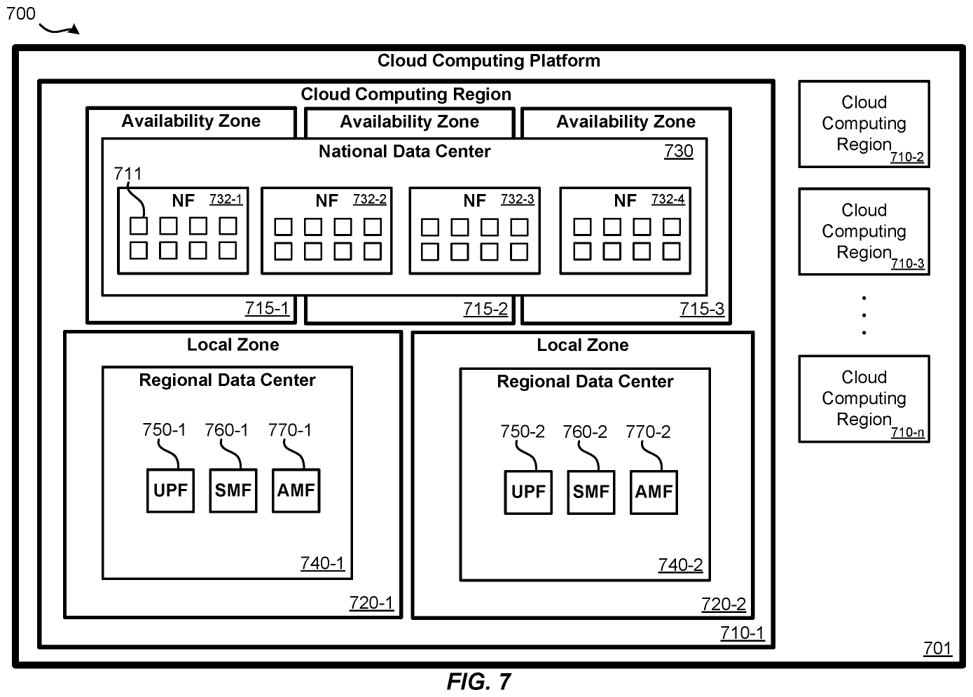

FIG. 6A illustrates an embodiment of a cellular network system 600 (“system 600”), according to certain embodiments. System 600 can include a fifth generation (5G) New Radio (NR) cellular network; other types of cellular networks, such as fourth generation (4G) long-term evolution (LTE) cellular network, sixth generation (6G) cellular network, seventh generation (7G) cellular network, etc. are also possible. System 600 can include: UE 610 (UE 610-1, UE 610-2, UE 610-3); base station 615; cellular network 620; radio units 625 (“RUs 625”); distributed units 627 (“DUs 627”); centralized unit 629 (“CU 629”); core 639, and orchestrator 638. FIG. 6A represents a component level view. In a virtualized open radio access network (O-RAN), because components can be implemented as software in the cloud, except for components that receive and transmit RF, the functionality of various components can be shifted among different servers, for which the hardware may be maintained by a separate (e.g., public) cloud-service provider, to accommodate where the functionality of such components is needed, such as detailed in relation to FIG. 7.

UE 610 can represent various types of end-user devices, such as smartphones, cellular modems, cellular-enabled computerized devices, sensor devices, manufacturing equipment, gaming devices, access points (APs), any computerized device capable of communicating via a cellular network, etc. UE can also represent any type of device that has incorporated a cellular (e.g., 5G) interface, such as a 5G modem. Examples include sensor devices, Internet of Things (IoT) devices, manufacturing robots; unmanned aerial (or land-based) vehicles, network-connected vehicles, environmental sensors, etc. UE 610 may use RF to communicate with various base stations of cellular network 620. Two base stations 615 (BS 615-1, 615-2) are illustrated. Real-world implementations of system 600 can include many (e.g., hundreds, thousands) base stations, and many RUs, DUs, and CUs. BS 615 can include one or more antennas that allow RUs 625 to communicate wirelessly with UEs 610. RUs 625 can represent an edge of cellular network 620 where data is transitioned to wireless communication. In some implementations, the radio access technology (RAT) used by RU 625 is 5G New Radio (NR). Other implementations use other RAT, such as 4G Long Term Evolution (LTE). The remainder of cellular network 620 may be based on an exclusive 5G architecture, a hybrid 4G/5G architecture, a 4G architecture, or some other cellular network architecture. Base station equipment 621 may include an RU (e.g., RU 625-1) and a DU (e.g., DU 627-1) located on site at the base station. In some embodiments, the DU may be physically remote from the RU. For instance, multiple DUs may be housed at a central location and connected to geographically distant (e.g., within a couple of kilometers) RUs.

One or more RUs, such as RU 625-1, may communicate with DU 627-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, “band 71” (a radiofrequency band near 600 Megahertz allocated for cellular communications). One or more DUs, such as DU 627-1, may communicate with CU 629. Collectively, RUs, DUs, and CUs create a gNodeB, which serves as the radio access network (RAN) of cellular network 620. CU 629 can communicate with core 639. The specific architecture of cellular network 620 can vary by embodiment. Edge cloud server systems outside of cellular network 620 may communicate, either directly, via the Internet, or via some other network, with components of cellular network 620. For example, one or more DUs 627-1 may be able to communicate with an edge cloud server system without routing data through CU 629 or core 639.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

Further detail regarding exemplary core 639 is provided in relation to FIG. 6B. FIG. 6B illustrates an exemplary core 639, according to certain embodiments. The exemplary core 639 can be physically distributed across data centers or located at a central national data center (NDC), such as detailed in relation to FIG. 7, can perform various core functions of the cellular network. Core 639 can include: network resource management components 650; policy management components 660; subscriber management components 670; and packet control components 680. Individual components may communicate via a bus, thus allowing various components of core 639 to communicate with each other directly. Core 639 is simplified to show some key components. Implementations can involve additional components.

Network resource management components 650 can include: Network Repository Function (NRF) 652 and Network Slice Selection Function (NSSF) 654. NRF 652 can allow 5G network functions (NFs) to register and discover each other via a standards-based application programming interface (API). NSSF 654 can be used by AMF 682 to assist with the selection of a network slice that will serve a particular UE (e.g., UEs 610 of FIG. 6A).

Policy management components 660 can include: Charging Function (CHF) 662 and Policy Control Function (PCF) 664. CHF 662 allows charging services to be offered to authorized network functions. Converged online and offline charging can be supported. PCF 664 allows for policy control functions and the related 5G signaling interfaces to be supported.

Subscriber management components 670 can include: Unified Data Management (UDM) 672 and Authentication Server Function (AUSF) 674. UDM 672 can allow for generation of authentication vectors, user identification handling, NF registration management, and retrieval of UE individual subscription data for slice selection. AUSF 674 performs authentication with UEs.

Packet control components 680 can include: Access and Mobility Management Function (AMF) 682 and Session Management Function (SMF) 684. AMF 682 can receive connection- and session-related information from UEs and is responsible for handling connection and mobility management tasks. SMF 684 is responsible for interacting with the decoupled data plane, creating updating and removing Protocol Data Unit (PDU) sessions, and managing session context with the User Plane Function (UPF).

User plane function (UPF) 690 can be responsible for packet routing and forwarding, packet inspection, quality of service (QOS) handling, and external PDU sessions for interconnecting with a Data Network (DN) (e.g., the Internet) or various access networks 697. Access networks 697 can include the RAN of cellular network 620 of FIG. 6A.

While FIGS. 6A and 6B illustrate various components of cellular network 620, it should be understood that other embodiments of cellular network 620 can vary the arrangement, communication paths, and specific components of cellular network 620. While RU 625 may include specialized radio access componentry to enable wireless communication with UE 610, other components of cellular network 620 may be implemented using either specialized hardware, specialized firmware, and/or specialized software executed on a general-purpose server system. In a virtualized arrangement, specialized software on general-purpose hardware may be used to perform the functions of components such as DU 627, CU 629, and core 639. Functionality of such components can be co-located or located at disparate physical server systems. For example, certain components of core 639 may be co-located with components of CU 629.

Returning to FIG. 6A, some O-RAN implementations of the DUs 627, CU 629, core 639, and/or orchestrator 638 are implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 600, cloud-based cellular network components 128 include CU 629, core 639, and orchestrator 638. In some embodiments, DUs 627 may be partially or fully added to cloud-based cellular network components 628. Such cloud-based cellular network components 628 may be executed as specialized software executed by underlying general-purpose computer servers. Cloud-based cellular network components 628 may be executed on a public third-party cloud-based computing platform or a cloud-based computing platform operated by the same entity that operates the RAN. A cloud-based computing platform may have the ability to devote additional hardware resources to cloud-based cellular network components 628 or implement additional instances of such components when requested. A “public” cloud-based computing platform refers to a platform where various unrelated entities can each establish an account and separately utilize the cloud computing resources, the cloud computing platform managing segregation and privacy of each entity's data.

Kubernetes, or some other container orchestration platform, can be used to create and destroy the logical DU, CU, or 5G core units and subunits, as needed, for the cellular network 620 to function properly. Kubernetes allows for container deployment, scaling, and management. As an example, if cellular traffic increases substantially in a region, an additional logical DU or components of a DU may be deployed in a data center near where the traffic is occurring without any new hardware being deployed; rather, processing and storage capabilities of the data center would be devoted to the needed functions. When the need for the logical DU or subcomponents of the DU no longer exists (i.e., when traffic subsequently decreases), Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 638. Orchestrator 638 can represent various software processes executed by underlying computer hardware. Orchestrator 638 can monitor cellular network 620 and determine the amount and location at which cellular network functions should be deployed to meet or attempt to meet service level agreements (SLAs) across slices of the cellular network.

Orchestrator 638 can allow for the instantiation of new cloud-based components of cellular network 620. As an example, to instantiate a new DU, orchestrator 638 can perform a pipeline of calling the DU code from a software repository incorporated as part of, or separate from, cellular network 620; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 620. Cellular network 620 is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 625-1 and DU 627-1; and a second set of network slices, which may only partially overlap or may be wholly different from the first set, may be reserved at RU 625-2 and DU 627-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 6A, UE 610 may be operating on one or more production slices of cellular network 620. As detailed later in this document, a UE that functions on a particular entity's local network may be assigned to a slice particular to the entity or a slice that provides a particular QoE for tasks to be performed by the entity's UE.

Components such as DUs 627, CU 629, orchestrator 638, and core 639 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

FIG. 7 illustrates an embodiment of a cellular network core network topology 700 as implemented on a public cloud-computing platform, according to certain embodiments. The cellular network core network topology 700 can be an implementation of the core 639 of FIGS. 6A and/or 6B. Cellular network core network topology 700 can represent how logical cellular network groups are distributed across cloud computing infrastructure of cloud computing platform 701. Cloud computing platform 701 can be logically and physically divided up into various different cloud computing regions 710. Each of cloud computing regions 710 can be isolated from other cloud computing regions to help provide fault tolerance, fail-over, load-balancing, and/or stability and each of cloud computing regions 710 can be composed of multiple availability zones, each of which can be a separate data center located in general proximity to each other (e.g., within 600 miles). Further, each of cloud computing regions 710 may provide superior service to a particular geographic region based on physical proximity. For example, cloud computing region 710-1 may have its datacenters and hardware located in the northeast of the United States while cloud computing region 710-2 may have its datacenters and hardware located in California. For simplicity, the details of the cellular network as executed in only cloud computing region 710-1 is illustrated. Similar components may be executed in other cloud computing regions of cloud computing regions 710 (710-2, 710-3, 710-n).

In other embodiments, cloud computing platform 701 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 710 may include multiple availability zones 715. Each of availability zones 715 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 715. For example, a database that is maintained as part of NDC 730 may be replicated across availability zones 715; therefore, if an availability zone of the cloud computing region is unavailable, a copy of the database remains up-to-date and available, thus allowing for continuous or near continuous functionality.

On a (e.g., public) cloud computing platform, cloud computing region 710-1 may include the ability to use a different type of data center or group of data centers, which can be referred to as local zones 720. For instance, a client, such as a provider of the hybrid cloud cellular network, can select from more options of the computing resources that can be reserved at an availability zone 715 compared to a local zone 720. However, a local zone 720 may provide computing resources nearby geographic locations where an availability zone 715 is not available. Therefore, to provide low latency, certain network components, such as regional data centers 740, can be implemented at local zones 720 rather than availability zones 715. In some circumstances, a geographic region can have both a local zone 720 and an availability zone 715.

In the topology of a 5G NR cellular network, 5G core functions of core 639 can logically reside as part of a national data center (NDC) 730. NDC 730 can be understood as having its functionality existing in cloud computing region 710-1 across multiple availability zones 715. At NDC 730, various network functions, such as NFs 732, are executed. For illustrative purposes, each NF 732, whether at NDC 730 or elsewhere located, can be comprised of multiple sub-components, referred to as pods (e.g., pod 711) that are each executed as a separate process by the cloud computing region 710. The illustrated number of pods 711 is merely an example; fewer or greater numbers of pods 711 may be part of the respective 5G core functions. It should be understood that in a real-world implementation, a cellular network core, whether for 5G or some other standard, can include many more network functions. By distributing NFs 732 across availability zones 715, load-balancing, redundancy, and fail-over can be achieved. In local zones 720, multiple regional data centers 740 can be logically present. Each of regional data centers 740 may execute 5G core functions for a different geographic region or group of RAN components. As an example, 5G core components that can be executed within an RDC, such as RDC 740-1, may be: UPFs 750, SMFs 760, and AMFs 770. While instances of UPFs 750 and SMFs 760 may be executed in local zones 720, SMFs 760 may be executed across multiple local zones 720 for redundancy, processing load-balancing, and fail-over.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, executing instructions stored in the non-transitory computer-readable medium causes the processors to perform steps of methods and/or to implement features of components described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method, comprising:
receiving, by a computing system, a plurality of messages;
determining, by the computing system and utilizing a machine learning model, a score for a respective message of the plurality of messages, the score representing a likelihood that the respective message is an illegitimate message;
updating, by the computing system, a rating of a respective sender associated with a respective message, based at least in part on the score of the respective message;
accessing, by the computing system, a database comprising a list of including a respective sender associated with the respective message, the respective sender associated with a rating; and
filtering, by the computing system, at least a portion of the plurality of messages based at least in part on the rating of the respective sender.

2. The method of claim 1, wherein the machine learning model is configured to identify a route of each respective message and the score is based at least in part on the route of each respective message.

3. The method of claim 1, wherein the machine learning model is configured to identify an illegitimate message of the plurality of messages based at least in part on the content of the illegitimate message, and the score is based at least in part on the content of the illegitimate message.

4. The method of claim 1, wherein the machine learning model comprises a large language model.

5. The method of claim 1, wherein determining, by the computing system utilizing a machine learning model, the score for the respective message of the plurality of messages further comprises:
determining, by the machine learning model, a context associated with the respective message of the plurality of messages, the context based on information associated with at least one of the respective message, the respective sender, and an intended recipient.

6. The method of claim 1, wherein the computing system is associated with an enterprise-level system.

7. The method of claim 1, wherein the machine learning model comprises natural language processing techniques.

8. A system comprising:
one or more processors;
a machine learning model configured to identify one or more attributes of a message and, based at least in part on the one or more attributes, determine if the message is an illegitimate message;
a rating module configured to assign a rating to a sender of the message, the rating associated with a trust level of sender;
a filtering module configured to filter the message from the sender; and
a non-transitory computer readable medium containing instructions that, when executed by the one or more processors, cause the system to perform operations to:
receive, by the system, a plurality of messages;
determine, by the machine learning model, a score for a respective message of the plurality of messages, the score based on the one or more attributes of the respective message representing a likelihood that the respective message is an illegitimate message;
access, by the rating module, a database comprising a list of including a respective sender associated with the respective message, the respective sender associated with a rating; and
update, by the rating module, the rating of the respective sender associated with the respective message, based at least in part on the score of the respective message; and
filter, by the filtering module, at least a portion of the plurality of messages based at least in part on the rating of the respective sender.

9. The system of claim 8, wherein the one or more attributes comprise at least one of an internet protocol (IP) address, metadata, and a message content.

10. The system of claim 8, wherein the machine learning model is configured to identify a route of the respective message and the score is based at least in part on the route of the respective message.

11. The system of claim 8, wherein the machine learning model is configured to identify an illegitimate message of the plurality of messages based at least in part on the content of the illegitimate message, and the score is based at least in part on the content of the illegitimate message.

12. The system of claim 8, wherein the machine learning model comprises a large language model.

13. The system of claim 8, wherein the machine learning model is retrained using feedback provided by a plurality of users.

14. The system of claim 8, wherein the computing system is associated with an enterprise-level system.

15. The system of claim 8, wherein the machine learning model comprises natural language processing techniques.

16. A non-transitory computer-readable medium comprising instructions that, when executed by one or more processors, cause the one or more processors to perform operations to:
receiving, by a computing system, a plurality of messages;
determining, by the computing system and utilizing a machine learning model, a score for a respective message of the plurality of messages, the score representing a likelihood that the respective message is an illegitimate message;
updating, by the computing system, a rating of a respective sender associated with a respective message, based at least in part on the score of the respective message;
accessing, by the computing system, a database comprising a list of including a respective sender associated with the respective message, the respective sender associated with a rating; and
filtering, by the computing system, at least a portion of the plurality of messages based at least in part on the rating of the respective sender.

17. The non-transitory computer-readable medium of claim 16, wherein the machine learning model comprises a large language model.

18. The non-transitory computer-readable medium of claim 16, wherein determining, by the computing system utilizing a machine learning model, the score for the respective message of the plurality of messages further comprises:
determining, by the machine learning model, a context associated with each respective message of the plurality of messages, the context based on information associated with at least one of the respective message, the respective sender, and an intended recipient.

19. The non-transitory computer-readable medium of claim 16, wherein the computing system is associated with an enterprise-level system.

20. The non-transitory computer-readable medium of claim 16, wherein the machine learning model comprises natural language processing techniques.
